(19) United States
(12) Patent Application Publication
(10) Pub. No.: US 2023/0117273 A1
(43) Pub. Date: Apr. 20, 2023

(54) PLUGGABLE FIRMWARE UPDATE MODULES FOR DOWNLOAD ACCELERATION AND CUSTOMIZABLE SECURITY VALIDATION

(71) Applicant: Dell Products L.P., Round Rock, TX (US)

(72) Inventors: Prashanth Giri, Round Rock, TX (US); Michael E. Brown, Austin, TX (US); Ching-Jye Chang, Cedar Park, TX (US); Antonio Ramos, Round Rock, TX (US); Santosh Bidaralli, Cedar Park, TX (US)

(21) Appl. No.: 17/504,120

(22) Filed: Oct. 18, 2021

(51) Int. Cl. H04L 29/06; H04L 29/08

(52) U.S. Cl. CPC H04L 63/123; H04L 67/108; H04L 67/1076; H04L 67/06

(57) ABSTRACT

An information handling system includes a host processor that instantiates a hosted environment. A baseboard management controller executes core firmware code to provide a first plurality of functions of the baseboard management controller. The first functions include a container management system. The container management system provides a plurality of extension slots. Each extension slot provides one of a second plurality of functions of the baseboard management controller.

### FIELD OF THE DISCLOSURE

This disclosure generally relates to information handling systems, and more particularly relates to pluggable firmware update modules for download acceleration and customizable security validation in an information handling system.

### BACKGROUND

As the value and use of information continues to increase, individuals and businesses seek additional ways to process and store information. One option is an information handling system. An information handling system generally processes, compiles, stores, and/or communicates information or data for business, personal, or other purposes. Because technology and information handling needs and requirements may vary between different applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, reservations, enterprise data storage, or global communications. In addition, information handling systems may include a variety of hardware and software resources that may be configured to process, store, and communicate information and may include one or more computer systems, data storage systems, and networking systems.

### SUMMARY

An information handling system includes a host processor that instantiates a hosted environment. A baseboard management controller executes core firmware code to provide a first plurality of functions of the baseboard management controller. The first functions include a container management system. The container management system provides a plurality of extension slots. Each extension slot provides one of a second plurality of functions of the baseboard management controller. The second functions differ from the first functions.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a block diagram of an information handling system according to an embodiment of the current disclosure;

FIG. 2 is a block diagram of a peer-to-peer network according to an embodiment of the current disclosure; and

FIG. 3 is a block diagram illustrating a generalized information handling system according to another embodiment of the current disclosure.

The use of the same reference symbols in different drawings indicates similar or identical items.

### DETAILED DESCRIPTION OF DRAWINGS

The following description in combination with the Figures is provided to assist in understanding the teachings disclosed herein. The following discussion will focus on specific implementations and embodiments of the teachings. This focus is provided to assist in describing the teachings, and should not be interpreted as a limitation on the scope or applicability of the teachings. However, other teachings can certainly be used in this application. The teachings can also be used in other applications, and with several different types of architectures, such as distributed computing architectures, client/server architectures, or middleware server architectures and associated resources.

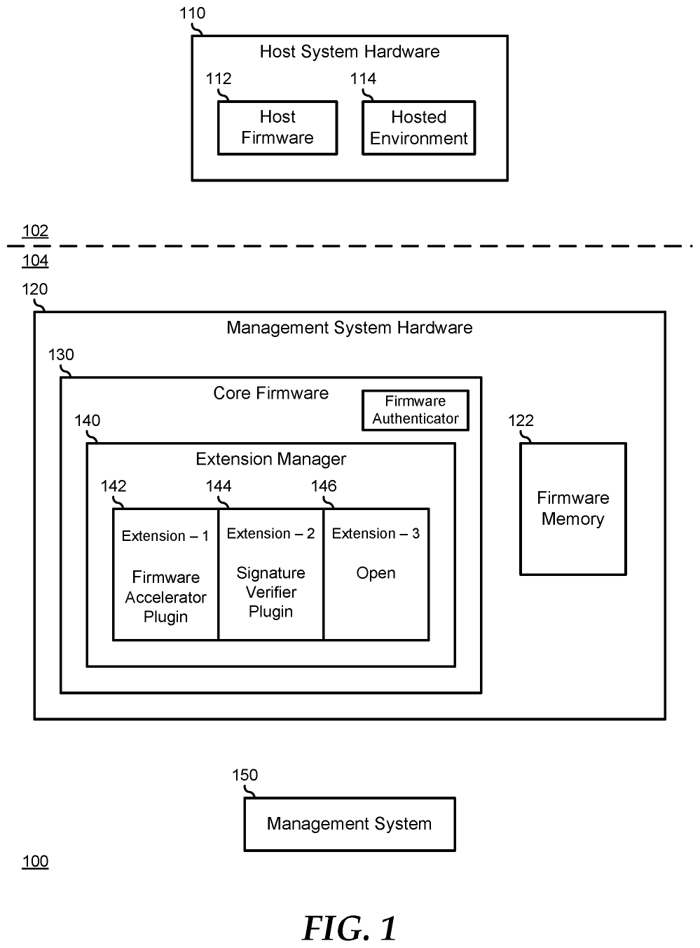

FIG. 1 illustrates an information handling system 100 including a host system environment 102 and a management system environment 104. Host system environment 102 represents the elements of information handling system 100 that perform the processing functions to which the information handling system is dedicated, and which are normally ascribed to the various types of information handling systems. For example, where information handling system 100 represents an element of datacenter equipment, host system environment 102 may represent the elements of the information handling system that perform the datacenter processing, data management and storage, data network routing and switching, or other data handling functions associated with the particular element of datacenter equipment.

As such, host system environment 102 includes host system hardware 110 that operates to execute various machine-executable code including host firmware 112 and a hosted environment 114. Host firmware 112 may include a Basic Input/Output System (BIOS), a Universal Extensible Firmware Interface (UEFI), or other system level firmware that operates to initialize host system hardware 110, and may further include various device level firmware, such as device drivers, and the like. Host firmware 112 may further operate to launch hosted environment 114, which operates at runtime to perform the processing functions of information handling system 100. In particular, hosted environment 114 may include an operating system, a virtual machine manager or hypervisor, or other software to provide an operating environment for information handling system 100. Hosted environment 114 may further include applications, programs, utilities, or other software as needed or desired. Host firmware 112 further provides interfaces through which the various elements of hosted environment 114 utilize the various elements of host system hardware 110, as needed or desired.

Management system environment 104 represents elements of information handling system 100 that are not typically associated with the processing functions to which the information handling system are dedicated. Rather, management system environment 104 operates to monitor, manage, and maintain the operations of information handling system 100 that are necessary to the reliable operation of the information handling system, but that, where such monitoring, management, and maintenance to be performed by host system environment 102, would degrade the processing capacity of the host system environment. For example, management system environment 104 may manage the thermal performance of information handling system 100 by monitoring various temperatures and control cooling fans to maintain the temperatures within desired limits, may manage the power consumption of the information handling system by controlling various voltage levels within the information handling system, may perform firmware updates on the various components of host system hardware 110, and may provide an interface to a management system 150 for reporting of system status information. Management system 150 may provide a centralized locus for the monitoring, management, and maintenance of multiple information handling systems similar to information handling system 100 within, for example, a datacenter environment.

Management system hardware 130 operates to execute machine-executable code including core firmware 130. In a typical information handling system, the core firmware will include a firmware updater that is hardcoded into the core firmware, and the functions and features of the core firmware are typically highly constrained. That is, the functions and features of the core firmware that are typically provided to all users of the common management system hardware, regardless of the particular needs of the user of the information handling system, or the type of information handling system that utilizes the management system hardware. As such, changes to the core firmware typically necessitate a high degree of testing to validate updates, increasing the cost of development of the core firmware. For this reason, the functions and features instantiated by the core firmware is not typically amenable to changing features to suit the customized needs of the user or the information handling system. Further, updating of the core firmware in the typical information handling system is provided in a client/server model where the core firmware is downloaded from a single update server to ensure the security of the update process, and the update process is typically based upon aging data protocols, such as HyperText Transfer Protocol (HTTP), File Transfer Protocol (FTP), Network File System (NFS), Common Internet File System (CIFS), or the like.

In a particular embodiment, core firmware 130 operates to provide a limited set of functions (core functions) and features that are typically common to all types of applications and uses of information handling system 100. For example, core firmware 130 may provide a firmware update mechanism, a web-based interface through which management system 150 can access management system environment, an Intelligent Platform Management Interface (IPMI) engine for monitoring, managing, and maintaining elements of information handling system 100, a passthrough engine such as a USB NIC, a BMC-to-OS interface, or the like to communicate with hosted environment 114, and other common functions and features, as needed or desired. In this way, core firmware 130 remains highly stable in terms of updates and maintenance because such functions and features are not subject to rapidly changing requirements or implementations, and the costs associated with maintaining the core firmware remain low.

In contrast to the functions and features instantiated by core firmware 130, the core firmware further instantiates an extension manager 140 that provides the capacity to install extensions 142, 144, and 146 that provide various more advanced features, and that permit more differentiation in the usage model of management system environment 104 as needed or desired by the user of information handling system 100. In a particular embodiment, extension manager 140 represents a highly segregated container management system, such as a Platform-as-a-Service or OS-level virtualization system, where each of extensions 142, 144, and 146 operate as a separate operating environment, and the extension manager isolates the resources of management system hardware 120 that are utilized by one extension from the resources that are utilized by any other extensions. In this way, the security of management system environment 104 is enhanced the inadvertent or intentional tampering by one extension with the resources or functions of any other extension is not possible.

An example of a highly segregated container manager may include a Docker container management system, a Linux-VServer implementation of a Linux core, a LXC (Linux Container) implementation, or another container manager, as needed or desired. In another embodiment, extension manager 140 represents an integrated extension management system, where each of extension 142, 144, and 146 operate as an application or program running on a common OS environment provided by core firmware 120, and where the extensions share the resources available to the OS environment. In yet another embodiment, extension manager 140 represents a firmware architecture specification that has published hooks, Application Programming Interfaces (APIs), procedures, Software Developer Kits (SDKs) or the like, that permit users of information handling system 100 to create and maintain pluggable firmware functions, features, updates, and the like.

Extension manager 140 permits the instantiation of highly customizable stand-alone functions and features that can be monitored, managed, and maintained separately from the functions and features of core firmware 130. In this way, the functionality of management system environment 104 can be tailored to the particular needs of the user of information handling system 100 in new ways that were not available with the typical management system firmware due to the cost, time, and complexity of maintaining and updating of unified management system firmware, as used in the prior art. As such, functions and features of a management system environment in accordance with the current embodiments become much more adaptable, robust, and inexpensive to maintain and update. In particular, where extension manager 140 represents a SDK, the extension manager can be tasked with maintaining security between the installed modules, and the development of the individual extensions can be performed on a schedule uncoupled from the cycle of core firmware updates.

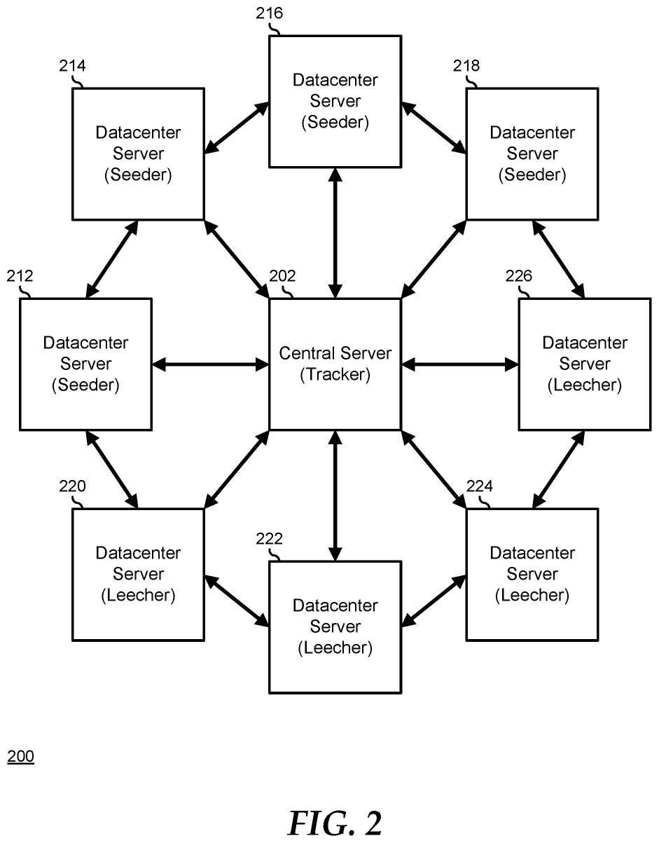

Extension 142 is illustrated as including a firmware accelerator plugin, extension 144 is illustrated as including a signature verifier plugin, and extension 146 is illustrated as being open for the inclusion of other types of plugins as needed or desired. The firmware accelerator plugin instantiated in extension 142 represents a peer-to-peer file sharing protocol that permits peer devices to upload and download various files to each other in a distributed manner. FIG. 2 illustrates an peer-to-peer network 200. Peer-to-peer network 200 include a central server 202, and peer devices 212, 214, 216, 218, 222, 224, 226, and 228. Central server 202 may represent a source node in a datacenter, such as a management system, that provides firmware updates to the peer devices. In a typical datacenter, central server 202 operates to download firmware updates on a client-server basis to each of the peer devices individually. For example, the data traffic bandwidth experienced by central server 202 for providing a 100 megabyte (MB) firmware updates to the peer devices would amount to 800 MB of data traffic (100 MB X 8 peer devices).

However, where the peer devices are each instantiated with a firmware accelerator plugin similar to the firmware plugin instantiated on extension manager 140 of FIG. 1, central server 202 operates as a tracker within peer-to-peer network 200, providing a tracker file to each of peer devices 212, 214, 216, 218, 222, 224, 226, and 228. The tracker file provides identifying information for the firmware update, including a map of separately transferrable chunks of the firmware update, and hash information for each of the separate chunks. With the tracker file downloaded from central server 202, peer devices 212, 214, 216, 218, 222, 224, 226, and 228 then operate to search peer-to-peer network 200 for other peer devices that include one or more of the separate chunks. Initially, a firmware update repository, typically central server 202, will include the firmware update, and peer devices 212, 214, 216, 218, 222, 224, 226, and 228 can begin to download the separate chunks from the firmware update repository.

However, as more of peer devices 212, 214, 216, 218, 222, 224, 226, and 228 download and retain more of the separate chunks, other, more closely networked peed devices can begin to download the separate chunks from the closest peer device. While downloading the separate chunks, a peer device will be described as a leecher, and while uploading the separate chunks, a peer device will be described as a seeder. Thus, while FIG. 2 illustrates peer devices 212, 214, 216, and 218 as being seeders and peer devices 222, 224, 226, and 228 as being leechers, each of the peer devices may operate as either a seeder, a leacher, or both, with respect to the various chunks at any given time. In this way, early in the process, the firmware repository will get several requests to download a firmware updated directly, and all chunks of the firmware update will be understood to be transferred by the firmware update repository at least once.

As the process proceeds, more and more of the separate chunks will be transferred between the peer devices, thereby reducing the data bandwidth utilization of the firmware repository. In a particular example, a network with three peer devices may transfer a 500 MB file. In the typical case, the central server utilizes 1500 MB (500 MB file multiplied by three nodes) to transfer the file. However, utilizing the peer-to-peer architecture, the central server will utilize 696 MB of bandwidth to transfer the file, including the tracker file, to all of the peer devices.

Returning to FIG. 1, the firmware accelerator plugin instantiated in extension 142 represents a peer-to-peer file transfer client, and management system 150 may be understood to include a peer-to-peer file transfer tracker, and may also include a firmware update repository. Here, when management system 150 needs to distribute a firmware update, the management system operates to push a tracker file to the firmware accelerator plugin, and the firmware accelerator plugin operates to search for peer nodes on a management network that include the separate chunks of the firmware update, and begins to act as a leecher, downloading the chunks from the peer network. Further, the firmware accelerator plugin advertises the availability of the downloaded chunks and acts as a seeder, uploading the chunks to other peer devices. In this way, firmware updates are distributed to the various nodes of the datacenter much more efficiently than in the typical client-server model. An example of a peer-to-peer file transfer system may include a torrent architecture, such as may be implemented by BitTorrent, or another torrent architecture, as needed or desired.

Note here that the firmware updates provided by the firmware update repository may include firmware for host system environment 102, such as host firmware 112, may include firmware for management system environment 104, such as core firmware 130, or may include updates to the elements instantiated in extensions 142, 144, and 146, as needed or desired. When information handling system 100 is first attached to the management network, management system 150 may operate to determine the firmware status for each element of firmware in the information handling system and to determine if there are relevant firmware updates for each element. Management system 150 can then provide a tacker file for each firmware element that needs to be updated, and the firmware accelerator plugin instantiated in extension 142 can proceed to download the associated firmware updates from the peer network. Once a particular firmware update is completely downloaded, the firmware file can be handed off to the particular firmware update mechanism instantiated in host firmware 112 or core firmware 130, as needed or desired.

In a particular embodiment, after a firmware file is downloaded, the firmware file is installed by a firmware update API in core firmware 130, as needed or desired. In another embodiment, management system hardware 120 includes a firmware memory 122. Here, a firmware file is downloaded to firmware memory 122 via, for example the firmware accelerator plugin instantiated in extension 142, prior to installation of the firmware update. In this way, management system 150 can push a firmware update to information handling system 100 and to other similar information handling systems, and can then separately direct the staged installation of the firmware updated on the information handling systems. Here further, the later installation of the firmware update on some of the information handling systems may be predicated upon the successful installation of the firmware update on the initial information handling systems, thereby avoiding the simultaneous installation of buggy or malfunctioning firmware across the entire datacenter.

The signature verifier plugin instantiated in extension 144 represents a firmware update authentication mechanism that is separate from the firmware update authentication mechanism instantiated in core firmware. In particular, where information handling system 100 is operated by a user with substantially increased security needs, such as a user that represents a government agency, a user that has heightened regulatory requirements, or the like. Here, the user can create the signature verifier plugin in accordance with proprietary design and implementation standards that are not subject to public scrutiny and that are completely under the control of the user. The signature verifier plugin may implement additional signature requirements, different verification and authentication algorithms, site-specific tagging to prevent firmware updates that are not received from a particular site, machine-specific tagging to prevent firmware updates that are not uniquely tagged to the particular information handling system, update blocking code to prevent the updating of core firmware 130 without prior authentication by the signature verifier plugin, or the like.

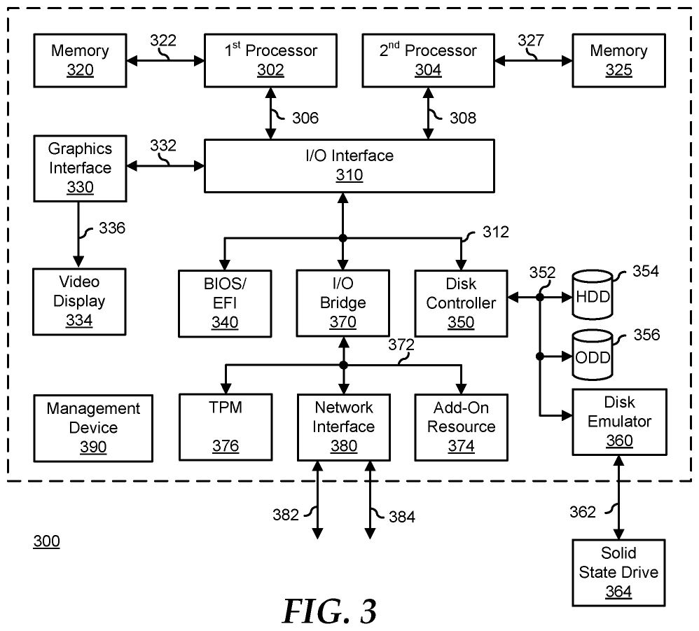

FIG. 3 illustrates a generalized embodiment of an information handling system 300. For purpose of this disclosure an information handling system can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 300 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 300 can include processing resources for executing machine-executable code, such as a central processing unit (CPU), a programmable logic array (PLA), an embedded device such as a System-on-a-Chip (SoC), or other control logic hardware.

Information handling system 300 can also include one or more computer-readable medium for storing machine-executable code, such as software or data. Additional components of information handling system 300 can include one or more storage devices that can store machine-executable code, one or more communications ports for communicating with external devices, and various input and output (I/O) devices, such as a keyboard, a mouse, and a video display. Information handling system 300 can also include one or more buses operable to transmit information between the various hardware components.

Information handling system 300 can include devices or modules that embody one or more of the devices or modules described below, and operates to perform one or more of the methods described below. Information handling system 300 includes a processors 302 and 304, an input/output (I/O) interface 310, memories 320 and 325, a graphics interface 330, a basic input and output system/universal extensible firmware interface (BIOS/UEFI) module 340, a disk controller 350, a hard disk drive (HDD) 354, an optical disk drive (ODD) 356, a disk emulator 360 connected to an external solid state drive (SSD) 364, an I/O bridge 370, one or more add-on resources 374, a trusted platform module (TPM) 376, a network interface 380, and a management device 390. Processors 302 and 304, I/O interface 310, memories 320 and 325, graphics interface 330, BIOS/UEFI module 340, disk controller 350, HDD 354, ODD 356, disk emulator 360, SSD 364, I/O bridge 370, add-on resources 374, TPM 376, and network interface 380 operate together to provide a host environment of information handling system 300 that operates to provide the data processing functionality of the information handling system. The host environment operates to execute machine-executable code, including platform BIOS/UEFI code, device firmware, operating system code, applications, programs, and the like, to perform the data processing tasks associated with information handling system 300.

In the host environment, processor 302 is connected to I/O interface 310 via processor interface 306, and processor 304 is connected to the I/O interface via processor interface 308. Memory 320 is connected to processor 302 via a memory interface 322. Memory 325 is connected to processor 304 via a memory interface 327. Graphics interface 330 is connected to I/O interface 310 via a graphics interface 332, and provides a video display output 336 to a video display 334. In a particular embodiment, information handling system 300 includes separate memories that are dedicated to each of processors 302 and 304 via separate memory interfaces. An example of memories 320 and 325 include random access memory (RAM) such as static RAM (SRAM), dynamic RAM (DRAM), non-volatile RAM (NV-RAM), or the like, read only memory (ROM), another type of memory, or a combination thereof.

BIOS/UEFI module 340, disk controller 350, and I/O bridge 370 are connected to I/O interface 310 via an I/O channel 312. An example of I/O channel 312 includes a Peripheral Component Interconnect (PCI) interface, a PCI-Extended (PCI-X) interface, a high-speed PCI-Express (PCIe) interface, another industry standard or proprietary communication interface, or a combination thereof. I/O interface 310 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. BIOS/UEFI module 340 includes BIOS/UEFI code operable to detect resources within information handling system 300, to provide drivers for the resources, initialize the resources, and access the resources. BIOS/UEFI module 340 includes code that operates to detect resources within information handling system 300, to provide drivers for the resources, to initialize the resources, and to access the resources.

Disk controller 350 includes a disk interface 352 that connects the disk controller to HDD 354, to ODD 356, and to disk emulator 360. An example of disk interface 352 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 360 permits SSD 364 to be connected to information handling system 300 via an external interface 362. An example of external interface 362 includes a USB interface, an IEEE 1394 (Firewire) interface, a proprietary interface, or a combination thereof. Alternatively, solid-state drive 364 can be disposed within information handling system 300.

I/O bridge 370 includes a peripheral interface 372 that connects the I/O bridge to add-on resource 374, to TPM 376, and to network interface 380. Peripheral interface 372 can be the same type of interface as I/O channel 312, or can be a different type of interface. As such, I/O bridge 370 extends the capacity of I/O channel 312 when peripheral interface 372 and the I/O channel are of the same type, and the I/O bridge translates information from a format suitable to the I/O channel to a format suitable to the peripheral channel 372 when they are of a different type. Add-on resource 374 can include a data storage system, an additional graphics interface, a network interface card (NIC), a sound/video processing card, another add-on resource, or a combination thereof. Add-on resource 374 can be on a main circuit board, on separate circuit board or add-in card disposed within information handling system 300, a device that is external to the information handling system, or a combination thereof.

Network interface 380 represents a NIC disposed within information handling system 300, on a main circuit board of the information handling system, integrated onto another component such as I/O interface 310, in another suitable location, or a combination thereof. Network interface device 380 includes network channels 382 and 384 that provide interfaces to devices that are external to information handling system 300. In a particular embodiment, network channels 382 and 384 are of a different type than peripheral channel 372 and network interface 380 translates information from a format suitable to the peripheral channel to a format suitable to external devices. An example of network channels 382 and 384 includes InfiniBand channels, Fibre Channel channels, Gigabit Ethernet channels, proprietary channel architectures, or a combination thereof. Network channels 382 and 384 can be connected to external network resources (not illustrated). The network resource can include another information handling system, a data storage system, another network, a grid management system, another suitable resource, or a combination thereof.

Management device 390 represents one or more processing devices, such as a dedicated baseboard management controller (BMC) System-on-a-Chip (SoC) device, one or more associated memory devices, one or more network interface devices, a complex programmable logic device (CPLD), and the like, that operate together to provide the management environment for information handling system 300. In particular, management device 390 is connected to various components of the host environment via various internal communication interfaces, such as a Low Pin Count (LPC) interface, an Inter-Integrated-Circuit (I2C) interface, a PCIe interface, or the like, to provide an out-of-band (00B) mechanism to retrieve information related to the operation of the host environment, to provide BIOS/UEFI or system firmware updates, to manage non-processing components of information handling system 300, such as system cooling fans and power supplies. Management device 390 can include a network connection to an external management system, and the management device can communicate with the management system to report status information for information handling system 300, to receive BIOS/UEFI or system firmware updates, or to perform other task for managing and controlling the operation of information handling system 300. Management device 390 can operate off of a separate power plane from the components of the host environment so that the management device receives power to manage information handling system 300 when the information handling system is otherwise shut down. An example of management device 390 include a commercially available BMC product or other device that operates in accordance with an Intelligent Platform Management Initiative (IPMI) specification, a Web Services Management (WSMan) interface, a Redfish Application Programming Interface (API), another Distributed Management Task Force (DMTF), or other management standard, and can include an Integrated Dell Remote Access Controller (iDRAC), an Embedded Controller (EC), or the like. Management device 390 may further include associated memory devices, logic devices, security devices, or the like, as needed or desired.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

1. An information handling system, comprising:
a host processor configured to instantiate a hosted environment; and
a baseboard management controller configured to operate out of band from the host processor to execute core firmware code to provide a first plurality of functions of the baseboard management controller, the first functions including a container management system, wherein the container management system provides a plurality of extension slots, each extension slot for providing one of a second plurality of functions of the baseboard management controller, the second functions differing from the first functions.

2. The information handling system of claim 1, wherein a first extension slot includes a firmware accelerator plugin.

3. The information handling system of claim 2, wherein the firmware accelerator plugin provides peer-to-peer filesharing.

4. The information handling system of claim 3, wherein the firmware accelerator is a BitTorrent client.

5. The information handling system of claim 4, wherein a second extension slot includes a signature verifier plugin.

6. The information handling system of claim 5, wherein the signature verifier plugin provides a first authentication for a file downloaded onto the information handling system via the firmware accelerator plugin.

7. The information handling system of claim 6, wherein the first functions include a firmware authenticator to provide a second authentication for the file.

8. The information handling system of claim 7, wherein the first and second authentications are both performed on the file.

9. The information handling system of claim 5, further comprising:
a memory device, wherein the firmware accelerator plugin is configured to download a firmware file to the memory device, and wherein the baseboard management controller is further configured to install the firmware file in response to a direction from a management system coupled to the baseboard management controller.

10. The information handling system of claim 9, wherein the management system directs the baseboard management controller to retain the firmware file without installing the firmware file prior to sending the direction to the baseboard management controller.

11. A method, comprising:
instantiating, on a host processor of an information handling system, a hosted environment;
executing, on a baseboard management controller of the information handling system, core firmware code to provide a first plurality of functions of the baseboard management controller, the first functions including a container management system, wherein in executing the core firmware code, the baseboard management system operates out of band from the host processor; and
providing, on the container management system, a plurality of extension slots, each extension slot for providing one of a second plurality of functions of the baseboard management controller, the second functions differing from the first functions.

12. The method of claim 11, wherein a first extension slot includes a firmware accelerator plugin.

13. The method of claim 12, wherein the firmware accelerator plugin provides peer-to-peer filesharing.

14. The method of claim 13, wherein the firmware accelerator is a BitTorrent client.

15. The method of claim 14, wherein a second extension slot includes a signature verifier plugin.

16. The method of claim 15, further comprising providing, by the signature verifier plugin, a first authentication for a file downloaded onto the information handling system via the firmware accelerator plugin.

17. The method of claim 16, wherein the first functions include a firmware authenticator, the method further comprising providing, by the firmware authenticator, a second authentication for the file.

18. The method of claim 17, wherein the first and second authentications are both performed on the file.

19. The method of claim 15, further comprising:
downloading, by the firmware accelerator plugin, a firmware file to a memory device of the information handling system;
installing, by the baseboard management controller, the firmware file in response to a direction from a management system coupled to the baseboard management controller; and
directing, by the management system, the baseboard management controller to retain the firmware file without installing the firmware file prior to sending the direction to the baseboard management controller.

20. An information handling system, comprising:
a host processor configured to instantiate a hosted environment; and
a baseboard management controller configured to operate out of band from the host processor to execute core firmware code to provide a first plurality of functions of the baseboard management controller, the first functions including a container management system, wherein the container management system provides a plurality of extension slots, each extension slot for providing one of a second plurality of functions of the baseboard management controller, the second functions differing from the first functions;
wherein:
a first extension slot includes a firmware accelerator plugin that provides peer-to-peer filesharing;
a second extension slot includes a signature verifier plugin;
the firmware accelerator plugin configured to download a firmware file to a memory device; and
the baseboard management controller further configured to install the firmware file in response to a direction from a management system coupled to the baseboard management controller.
